(19) United States
(12) Patent Application Publication
(10) Pub. No.: US 2005/0285086 A1
(43) Pub. Date: Dec. 29, 2005

(54) Flame retardant composition

(76) Inventors: Kazunari Kosaka, Shimotsuga-gun (JP); Xiucuo Li, Shanghai (CN); Xuedong Li, Shanghai (CN); Vijay Mhetar, Slingerlands, NY (US); Weiguang Yao, Moka-shi (JP)

Correspondence Address: CANTOR COLBURN, LLP, 55 GRIFFIN ROAD SOUTH, BLOOMFIELD, CT, 06002, US

(21) Appl. No.: 10/881,818

(22) Filed: Jun. 29, 2004

(51) Int. Cl. C09K 21/00

(52) U.S. Cl. 252/609

(57) ABSTRACT

A flame retardant additive composition comprising a phosphoric acid salt selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide and combinations of two or more of the foregoing; a metal hydroxide; and an organic phosphate. The flame retardant additive is useful in a wide range of thermoplastic compositions.

### CROSS REFERENCE TO RELATED APPLICATIONS

This application is claims priority to Provisional Application Ser. No. ______, filed on Apr. 1, 2004 (Attorney docket number 140963-1), which is incorporated by reference herein.

### BACKGROUND OF INVENTION

The disclosure relates to flame retardant additive compositions. In particular, the invention relates to flame retardant additive compositions useful in a variety of thermoplastics.

A wide variety of applications require flame retardant thermoplastic compositions. In addition to being flame retardant, the thermoplastic compositions must often meet a range of criteria ranging from physical performance to appearance to environmental impact. In recent years there has been an increasing trend to employ phosphates as the flame retardant in order to meet many or all of these criteria. While the use of phosphates has been successful in many instances, highly flammable compositions have continued to be problematic. Highly flammable thermoplastic compositions frequently require high levels of phosphate flame retardants to obtain the desired level of flame retardancy but high levels of phosphate flame retardants can result in objectionable physical properties such as plate-out and migration. Plate out and migration refer to the movement of solid and liquid component to the surface of the article as evidenced in some cases by a powdery or tacky feel to the surface. Other flame retardants such as magnesium hydroxide and aluminum trihydrate are known but at high levels frequently have a negative impact on physical properties.

Accordingly there remains a need in the art for a flame retardant composition that provides excellent flame retardance to thermoplastic compositions and has little or no negative impact on the physical properties of the thermoplastic composition.

### BRIEF DESCRIPTION OF THE INVENTION

The above mentioned need is met by a flame retardant additive composition comprising:
a phosphoric acid salt selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide and combinations of two or more of the foregoing;
a metal hydroxide; and
an organic phosphate.

In another embodiment, a flame retardant thermoplastic composition comprises:
a thermoplastic resin,
a phosphoric acid salt selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide and combinations of two or more of the foregoing;
a metal hydroxide; and
an organic phosphate.

### DETAILED DESCRIPTION

The flame retardant additive composition comprises a phosphoric acid salt selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide and combinations of two or more of the foregoing; a metal hydroxide; and an organic phosphate. The flame retardant additive composition has the advantage of providing excellent flame retardance at lower levels of organic phosphate than organic phosphate alone, thus decreasing or eliminating plate-out and migration in thermoplastic compositions. The flame retardant additive composition may be used with a wide range of thermoplastics and combinations of thermoplastics to decrease the flammability of the thermoplastic and to yield flame retardant thermoplastic compositions.

In one embodiment the flame retardant additive composition consists essentially of a phosphoric acid salt selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide and combinations of two or more of the foregoing; a metal hydroxide; and an organic phosphate. “Consisting essentially of” as used herein allows the inclusion of additional components as long as those additional components do not materially affect the basic and novel characteristics of the flame retardant additive, such as the ability to provide the same or greater level of flame retardance to a thermoplastic composition at lower levels of organic phosphate than organic phosphate alone and/or being essentially free (containing less than 0.05 weight percent, or, more specifically less than 0.005 weight percent, based on the combined weight of phosphoric acid salt, metal hydroxide and organic phosphate) of chlorine and bromine.

In another embodiment the flame retardant additive composition consists of a phosphoric acid salt selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide and combinations of two or more of the foregoing; a metal hydroxide; and an organic phosphate.

The phosphoric acid salt is selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide and combinations of two or more of the foregoing phosphoric acid salts. The phosphoric acid salt may be surface coated with one or more of compounds selected from melamine monomer, melamine resin, modified melamine resin, guanamine resin, epoxy resin, phenol resin, urethane resin, urea resin, silicone resin, and the like. The identity of the surface coating when present is typically chosen based upon the identity of the thermoplastic components of the fire retardant thermoplastic composition. In one embodiment the phosphoric acid salt comprises melamine polyphosphate.

Phosphoric acid salts are commercially available or can be synthesized by the reaction of a phosphoric acid with the corresponding amine containing compound as is taught in the art.

The phosphoric acid salt may be present in the flame retardant additive composition in an amount of 10 to 40 weight percent, based on the combined weight of phosphoric acid salt, metal hydroxide and organic phosphate. Within this range the phosphoric acid salt may be present in an amount greater than or equal to 12, or, more specifically, greater than or equal to 15, or, even more specifically, greater than or equal to 18 weight percent based on the combined weight of phosphoric acid salt, metal hydroxide and organic phosphate. Also within this range the phosphoric acid salt may be present in an amount less than or equal to 38, or, more specifically, less than or equal to 35, or, even more specifically, less than or equal to 28 weight percent based on the combined weight of phosphoric acid salt, metal hydroxide and organic phosphate.

Suitable metal hydroxides include all those capable of providing fire retardance, as well as combinations thereof. The metal hydroxide may be chosen to have substantially no decomposition during processing of the fire additive composition and/or flame retardant thermoplastic composition. Substantially no decomposition is defined herein as amounts of decomposition that do not prevent the fire retardant additive composition from providing the desired level of fire retardance. Exemplary metal hydroxides include, but are not limited to, magnesium hydroxide, aluminum hydroxide, cobalt hydroxide and combinations of two or more of the foregoing. In one embodiment, the metal hydroxide comprises magnesium hydroxide. In some embodiments the metal hydroxide has an average particle size less than or equal to 10 micrometers and/or a purity greater than or equal to 90 weight percent. In some embodiments it is desirable for the metal hydroxide to contain substantially no water, i.e. a weight loss of less than 1 weight percent upon drying at 120° C. for 1 hour. In some embodiments the metal hydroxide may be coated, for example, with stearic acid or other fatty acid.

The metal hydroxide may be present in the flame retardant additive composition in an amount of 10 to 45 weight percent, based on the combined weight of phosphoric acid salt, metal hydroxide and organic phosphate. Within this range the metal hydroxide may be present in an amount greater than or equal to 12, or, more specifically, greater than or equal to 15, or, even more specifically, greater than or equal to 18 weight percent based on the combined weight of phosphoric acid salt, metal hydroxide and organic phosphate. Also within this range the metal hydroxide may be present in an amount less than or equal to 40, or, more specifically, less than or equal to 35, or, even more specifically, less than or equal to 30 weight percent based on the combined weight of phosphoric acid salt, metal hydroxide and organic phosphate.

In one embodiment the weight ratio of metal hydroxide to phosphoric acid salt is greater than or equal to 0.8, or, more specifically, greater than or equal to 1.0.

The organic phosphate may be an aromatic phosphate compound of the formula (IX): 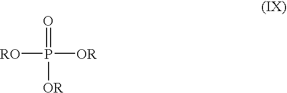
where each R is independently an alkyl, cycloalkyl, aryl, alkyl substituted aryl, halogen substituted aryl, aryl substituted alkyl, halogen, or a combination of any of the foregoing, provided at least one R is aryl or alkyl substituted aryl.

Examples include phenyl bisdodecyl phosphate, phenylbisneopentyl phosphate, phenyl-bis (3,5,5′-tri-methyl-hexyl phosphate), ethyldiphenyl phosphate, 2-ethyl-hexyldi(p-tolyl) phosphate, bis-(2-ethylhexyl) p-tolylphosphate, tritolyl phosphate, bis-(2-ethylhexyl) phenyl phosphate, tri-(nonylphenyl) phosphate, di (dodecyl) p-tolyl phosphate, tricresyl phosphate, triphenyl phosphate, dibutylphenyl phosphate, 2-chloroethyldiphenyl phosphate, p-tolyl bis(2,5,5′-trimethylhexyl) phosphate, 2-ethylhexyldiphenyl phosphate, and the like. In one embodiment the phosphate is one in which each R is aryl and/or alkyl substituted aryl, such as triphenyl phosphate and tris(alkyl phenyl) phosphate.

Alternatively, the organic phosphate can be a di- or polyfunctional compound or polymer having the formula (X), (XI), or (XII) below: 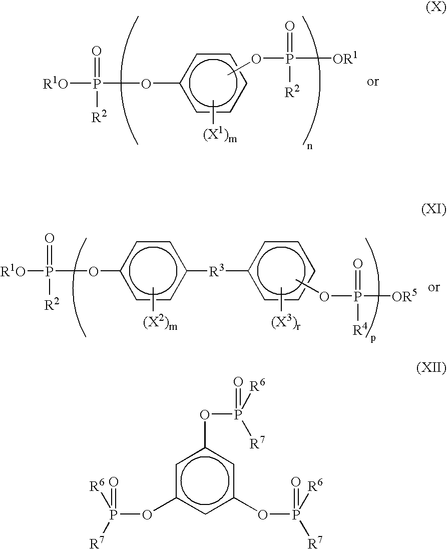
including mixtures thereof, in which R¹, R³ and R⁵ are, independently, hydrocarbon; R², R⁴, R⁶ and R⁷ are, independently, hydrocarbon or hydrocarbonoxy; X¹, X² and X³ are, independently, halogen; m and r are 0 or integers from 1 to 4, and n and p are from 1 to 30.

Examples include the bis diphenyl phosphates of resorcinol, hydroquinone and bisphenol-A, respectively, or their polymeric counterparts.

Methods for the preparation of the aforementioned di- and polyfunctional aromatic phosphates are described in British Patent No. 2,043,083.

Exemplary organic phosphates include, but are not limited to, phosphates containing substituted phenyl groups, phosphates based upon resorcinol such as, for example, resorcinol tetraphenyl diphosphate, as well as those based upon bis-phenols such as, for example, bis-phenol A tetraphenyl diphosphate. In one embodiment, the organic phosphate is selected from tris(butyl phenyl) phosphate (CAS No. 89492-23-9, and 78-33-1), resorcinol diphosphate (for example, CAS No. 57583-54-7), bis-phenol A diphosphate (for example, CAS No. 181028-79-5), triphenyl phosphate (CAS No. 115-86-6), tris(isopropyl phenyl) phosphate (CAS No. 68937-41-7) and mixtures of two or more of the foregoing.

The organic phosphate may be present in the flame retardant additive composition in an amount of 15 to 80 weight percent, based on the total weight of the flame retardant additive composition. Within this range the organic phosphate may be present in an amount greater than or equal to 25, or, more specifically, greater than or equal to 30, or more specifically, greater than or equal to 35 based on the total weight of the flame retardant additive composition. Also within this range the organic phosphate may be present in an amount less than or equal to 75, more specifically, less than or equal to 70, or, even more specifically, less than or equal to 65 based on the total weight of the flame retardant additive composition.

In one embodiment the fire retardant additive composition may comprise 5 to 30 mole percent (mol %) phosphorous, 23 to 79 mol % nitrogen, and 7 to 68 mol % metal hydroxide, based on the total moles of phosphorous, nitrogen and metal hydroxide.

Within the preceding range the phosphorous may be present in an amount greater than or equal to 6 mol %, or, more specifically, in an amount greater than or equal to 10 mol %. Also within the preceding range the phosphorous may be present in an amount less than or equal to 28 mol %, or, more specifically in an amount less than or equal to 24 mol %.

Within the preceding range the nitrogen may be present in an amount greater than or equal to 30 mol %, or, more specifically, in an amount greater than or equal to 40 mol %. Also within the preceding range the nitrogen containing may be present in an amount less than or equal to 70 mol %, or, more specifically in an amount less than or equal to 60 mol %.

Within the preceding range the metal hydroxide may be present in an amount greater than or equal to 15 mol %, or, more specifically, in an amount greater than or equal to 20 mol %. Also within the preceding range the metal hydroxide may be present in an amount less than or equal to 55 mol %, or, more specifically in an amount less than or equal to 45 mol %.

The components of the flame retardant additive composition may be mixed together to form an additive composition. Alternatively, as discussed in detail below, the components may be blended with a thermoplastic to form a masterbatch or added individually, simultaneously, sequentially or a combination thereof, to the thermoplastic composition during or after its formation.

The flame retardant thermoplastic composition comprises a thermoplastic resin in addition to the flame retardant additive composition. The thermoplastic resin may be selected from the group consisting of poly(arylene ether); poly(arylene ether) blends; styrenic polymers and copolymers and their blends; polyolefin; polyolefin blends; polyethers and their blends; and polyamides and their blends. Exemplary poly(arylene ether) blends include compatibilized poly(arylene ether)/polyamide blends; poly(arylene ether)/polyolefin blends such as poly(arylene ether)/olefinic thermoplastics vulcanizates, poly(arylene ether)/ethylene-propylene rubber, and poly(arylene/ether)/EPDM; poly(arylene ether)/styrenic polymer or copolymer blends; impact modified poly(arylene ether) blends; and poly(arylene ether)/thermoplastic polyurethane blends. Flame retardant thermoplastic composition is herein defined as a thermoplastic composition having, according to the procedure of Underwriter's Laboratory Bulletin 94 entitled “Tests for Flammability of Plastic Materials, UL94” (UL94) at a thickness of 3.2 millimeters, a V2 rating or better. In one embodiment the flame retardant thermoplastic composition has a V1 rating or better. In another embodiment the flame retardant thermoplastic composition has a V0 rating.

In one embodiment the thermoplastic resin comprises poly(arylene ether) and an impact modifier. The thermoplastic resin may additionally comprise a polyolefin. In this embodiment the phosphoric acid salt may also be melem polyphosphate or melam polyphosphate.

In one embodiment, the flame retardant thermoplastic composition has a Durometer hardness (Shore A), as determined by ASTM D 2240 measured on a specimen having a 3 millimeter thickness, greater than or equal to 60. The Shore A hardness may be greater than or equal to 65 or greater than or equal to 70. The composition may have a Shore D hardness, as determined by ASTM D 2240 measured on a specimen having a 3 millimeter thickness, of 20 to 60. Within this range the Shore D hardness may be greater than or equal to 23 or greater than or equal to 26. Also within this range the Shore D hardness may be less than or equal to 55 or less then or equal to 50.

In some embodiments the flexible composition has a flexural modulus, as determined by ASTM D790 using bars with a thickness of 6.4 millimeters (mm), of less than or equal to 1172 megapascals (MPa). The flexural modulus may be less than or equal to 517 MPa or less than or equal to 482 MPa. A flame retardant thermoplastic composition with the above described Shore A and flexural modulus finds use in a variety of applications requiring a flexible material, particularly wire coating and film, tubes, ducts, electrical insulator, insulation barrier, insulation breaker plate, wall paper, pipe and other applications where the combination of flame retardance, softness and flexibility are required. For example, a coated wire comprising an electrically conductive wire at least partially covered by the thermoplastic composition. The coated wire may additionally comprise an adhesion promoting layer disposed between the electrically conductive wire and the thermoplastic composition.

In some embodiments the flame retardant thermoplastic composition may have a tensile strength greater than or equal to 7.0 megapascals and a tensile elongation greater than or equal to 100%, or, more specifically, greater than or equal to 200%, or, even more specifically, greater than or equal to 300%. Tensile strength and elongation are both determined by ASTM D638 on Type I specimens having a thickness of 3.1 millimeters.

As used herein, a “poly(arylene ether)” comprises a plurality of structural units of the formula (I): 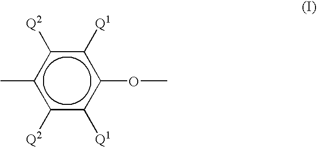
wherein for each structural unit, each Q¹ is independently halogen, primary or secondary lower alkyl (e.g., an alkyl containing 1 to 7 carbon atoms), phenyl, haloalkyl, aminoalkyl, alkenylalkyl, alkynylalkyl, hydrocarbonoxy, and halohydrocarbonoxy wherein at least two carbon atoms separate the halogen and oxygen atoms; and each Q² is independently hydrogen, halogen, primary or secondary lower alkyl, phenyl, haloalkyl, aminoalkyl, alkenylalkyl, alkynylalkyl, hydrocarbonoxy, halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are 4-hydroxybiphenyl end groups, typically obtained from reaction mixtures in which a polymerization reaction by-product, diphenoquinone, is present.

The poly(arylene ether) may be in the form of a homopolymer; copolymer; graft copolymer; ionomer; block copolymer, for example comprising arylene ether units and blocks derived from alkenyl aromatic compounds; as well as combinations comprising at least one of the foregoing. Poly(arylene ether) includes polyphenylene ether containing 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

The poly(arylene ether) can have a number average molecular weight of 3,000 to 40,000 atomic mass units (amu) and a weight average molecular weight of 5,000 to 80,000 amu, as determined by gel permeation chromatography. The poly(arylene ether) can have an intrinsic viscosity of 0.10 to 0.60 deciliters per gram (dl/g), or, more specifically, 0.29 to 0.48 dl/g, as measured in chloroform at 25° C. It is possible to utilize a combination of high intrinsic viscosity poly(arylene ether) and a low intrinsic viscosity poly(arylene ether). Determining an exact ratio, when two intrinsic viscosities are used, will depend somewhat on the exact intrinsic viscosities of the poly(arylene ether) used and the ultimate physical properties that are desired.

In one embodiment the poly(arylene ether) may be present in the flame retardant thermoplastic composition in an amount of 5 to 65 weight percent, based on the total weight of the flame retardant thermoplastic composition. Within this range the poly(arylene ether) may be present in an amount greater than or equal to 10, or, more specifically, greater than or equal to 15 weight percent, or, even more specifically, greater than or equal to 17 weight percent, based on the total weight of the flame retardant thermoplastic composition. Also within this range the poly(arylene ether) may be present in an amount less than or equal to 50, or, more specifically, less than or equal to 45, or, even more specifically, less than or equal to 40 weight percent based on the total weight of the flame retardant thermoplastic composition.

Particularly suitable thermoplastic impact modifiers are block copolymers, for example, A-B diblock copolymers and A-B-A triblock copolymers having of one or two alkenyl aromatic blocks A, which are typically styrene blocks or blocks of a copolymer of styrene and one or more 1,3-cyclodienes such as 1,3-cyclohexadiene, and a rubber block, B, which may be a polymer or copolymer block resulting from the polymerization of a conjugated diene such as butadiene, a 1,3-cyclodiene such as 1,3-cyclohexadiene or a combination of conjugated dienes or a copolymer block resulting from the copolymerization of a conjugated diene and an alkenyl aromatic compound. The copolymer block itself may be a block copolymer. The repeating units resulting from the polymerization of the conjugated dienes may be partially or completely hydrogenated. Each occurrence of alkenyl aromatic block A may have a molecular weight which is the same or different than other occurrences of alkenyl aromatic block A. Similarly each occurrence of rubber block B may have a molecular weight which is the same or different than other occurrences rubber block B.

Exemplary A-B and A-B-A copolymers include, but are not limited to, polystyrene-polybutadiene, polystyrene-poly(ethylene-propylene), polystyrene-polyisoprene, poly(α-methylstyrene)-polybutadiene, polystyrene-polybutadiene-polystyrene (SBS), polystyrene-poly (ethylene-propylene)-polystyrene, polystyrene-poly(ethylene-butylene)-polystyrene, polystyrene-(ethylene-butylene/styrene copolymer)-polystyrene, polystyrene-polyisoprene-polystyrene, and poly(alpha-methylstyrene)-polybutadiene-poly(alpha-methylstyrene), as well as the selectively hydrogenated versions thereof, and the like. Mixtures of the aforementioned block copolymers are also useful. Such A-B and A-B-A block copolymers are available commercially from a number of sources, including Phillips Petroleum under the trademark SOLPRENE, Kraton Polymers Ltd. under the trademark KRATON, Dexco under the trademark VECTOR, and Kuraray under the trademark SEPTON.

In one embodiment the impact modifier comprises impact modifiers having varying amounts of alkenyl aromatic blocks. For example a combination of a polystyrene-poly(ethylene-butylene)-polystyrene having a polystyrene content of 10 weight percent to 20 weight percent, based on the total weight of the block copolymer and a polystyrene-poly(ethylene-butylene)-polystyrene having a polystyrene content of 25 weight percent to 50 weight percent, based on the total weight of the block copolymer.

In one embodiment the impact modifier comprises a hydrogenated block copolymer of formula A-B, A-B-A, or (A-B)ₙX where prior to hydrogenation each A block is a mono alkenyl aromatic block and each B block is a controlled distribution copolymer block of at least one conjugated diene and at least one mono alkenyl aromatic compound. Subsequent to hydrogenation 0-10% of the alkenyl aromatic double bonds have been reduced and at least 90% of the conjugated double bonds have been reduced. Each A block has an average molecular weight of 3,000 to 60,000 amu and each B block has an average molecular weight of 30,000 to 300,000 amu. Each B block comprises at least one terminal region adjacent to the A blocks that are rich in conjugated diene units and a region not adjacent to the A block that is rich in mono alkenyl aromatic blocks. The total amount of mono alkenyl aromatic blocks is 15 to 75 weight percent, based on the total weight of the block copolymer. The weight ratio of conjugated diene blocks to mono alkenyl aromatic blocks in the B block is 5:1 to 1:2. Exemplary block copolymers are further disclosed in U.S. patent application Ser. No. 2003/181584.

In some embodiments the impact modifier is present in an amount sufficient to attain a combination of softness (as described above by Shore A and Shore D) and flexural modulus (as described above). The impact modifier may be present in the flame retardant thermoplastic composition in an amount of 5 to 50 weight percent, based on the total weight of the flame retardant thermoplastic composition. Within this range the impact modifier may be present in an amount greater than or equal to 8, or, more specifically, greater than or equal to 12, or, even more specifically, greater than or equal to 15 weight percent based on the total weight of the flame retardant thermoplastic composition. Also within this range the impact modifier may be present in an amount less than or equal to 45, or, more specifically, less than or equal to 40, or, even more specifically, less than or equal to 35 weight percent based on the total weight of the flame retardant thermoplastic composition.

The flame retardant thermoplastic composition may optionally comprise a polyolefin. Polyolefins which can be included are of the general structure: CₙH₂ₙ and include, for example, polyethylene, polybutene, polypropylene, polyisobutylene, and combinations of one or more of the foregoing, with preferred homopolymers being polybutene, polyethylene, LDPE (low density polyethylene), LLDPE (linear low density polyethylene), HDPE (high density polyethylene), MDPE (medium density polyethylene), polypropylene, and combinations of two or more of the foregoing. Polyolefin resins of this general structure and methods for their preparation are well known in the art and are described for example in U.S. Pat. Nos. 2,933,480, 3,093,621, 3,211,709, 3,646,168, 3,790,519, 3,884,993, 3,894,999, 4,059,654, 4,166,055 and 4,584,334.

Copolymers of polyolefins may also be used such as copolymers of ethylene and alpha olefins having three to twelve carbons or functionalized alpha olefins having three to twelve carbons. Exemplary alpha olefins include propylene and 4-methylpentene-1,1-butene, 2-butene, 1-pentene, 2-pentene, 1-hexene, 2-hexene and 3-hexene etc. Exemplary functionalized alpha olefins include olefins such as ethylene functionalized with vinyl acetate, ethylene functionalized with acrylate and ethylene functionalized with substituted acrylate groups. Copolymers of ethylene and C₃-C₁₀ monoolefins and non-conjugated dienes, herein referred to as EPDM copolymers, are also suitable. Examples of suitable C₃-C₁₀ monoolefins for EPDM copolymers include propylene, 1-butene, 2-butene, 1-pentene, 2-pentene, 1-hexene, 2-hexene and 3-hexene. Suitable dienes include 1,4 hexadiene and monocylic and polycyclic dienes. Mole ratios of ethylene to other C₃-C₁₀ monoolefin monomers can range from 95:5 to 5:95 with diene units being present in the amount of from 0.1 to 10 mol %. EPDM copolymers can be functionalized with an acyl group or electrophilic group for grafting onto the polyphenylene ether as disclosed in U.S. Pat. No. 5,258,455.

The polyolefin, when used, may be present in the flame retardant thermoplastic composition in an amount of 2 to 50 weight percent, based on the total weight of the flame retardant thermoplastic composition. Within this range the polyolefin may be present in an amount greater than or equal to 2, or, more specifically, greater than or equal to 5, or, even more specifically, greater than or equal to 7 weight percent based on the total weight of the flame retardant thermoplastic composition. Also within this range the polyolefin may be present in an amount less than or equal to 40, or, more specifically, less than or equal to 30, or, even more specifically, less than or equal to 25 weight percent based on the total weight of the flame retardant thermoplastic composition.

The flame retardant thermoplastic composition may optionally comprise a poly(alkenyl aromatic) resin. The term “poly(alkenyl aromatic) resin” as used herein includes polymers prepared by methods known in the art including bulk, suspension, and emulsion polymerization, which contain at least 25% by weight of structural units derived from an alkenyl aromatic monomer of the formula 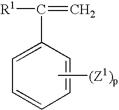
wherein R¹ is hydrogen, C₁-C₈ alkyl, or halogen; Z¹ is vinyl, halogen or C₁-C₈ alkyl; and p is 0 to 5. Preferred alkenyl aromatic monomers include styrene, chlorostyrene, and vinyltoluene. The poly(alkenyl aromatic) resins include homopolymers of an alkenyl aromatic monomer; non-elastomeric random, radial and tapered block copolymers of an alkenyl aromatic monomer, such as styrene, with one or more different monomers such as acrylonitrile, butadiene, alpha-methylstyrene, ethylvinylbenzene, divinylbenzene and maleic anhydride; and rubber-modified poly(alkenyl aromatic) resins comprising blends and/or grafts of a rubber modifier and a homopolymer of an alkenyl aromatic monomer (as described above), wherein the rubber modifier may be a polymerization product of at least one C₄-C₁₀ nonaromatic diene monomer, such as butadiene or isoprene, and wherein the rubber-modified poly(alkenyl aromatic) resin comprises 98 to 70 weight percent of the homopolymer of an alkenyl aromatic monomer and 2 to 30 weight percent of the rubber modifier. Rubber-modified polystyrenes are also known as high-impact polystyrenes or HIPS. In one embodiment the rubber-modified poly(alkenyl aromatic) resin comprises 88 to 94 weight percent of the homopolymer of an alkenyl aromatic monomer and 6 to 12 weight percent of the rubber modifier.

The composition may comprise the poly(alkenyl aromatic) resin, when present, in an amount of 1 to 46 weight percent, based on the total weight of the flame retardant thermoplastic composition. Within this range the poly(alkenyl aromatic) resin may be present in an amount greater than or equal to 2, or, more specifically, greater than or equal to 4, or, even more specifically, greater than or equal to 6 weight percent based on the total weight of the flame retardant thermoplastic composition. Also within this range the poly(alkenyl aromatic) resin may be present in an amount less than or equal to 25, or, more specifically, less than or equal to 20, or, even more specifically, less than or equal to 15 weight percent based on the total weight of the flame retardant thermoplastic composition.

In general the fire retardant thermoplastic composition comprises the fire retardant additive composition in an amount sufficient to attain a V2 rating or better at a thickness of 3.2 millimeters according to UL94. The fire retardant thermoplastic composition may comprise the fire retardant additive in an amount of 15 to 45 weight percent, based on the total weight of the thermoplastic composition. Within this range the fire retardant additive composition may be present in an amount greater than or equal to 18, or, more specifically, greater than or equal to 20, or, even more specifically, greater than or equal to 23 weight percent based on the total weight of the flame retardant thermoplastic composition. Also within this range the fire retardant additive composition may be present in an amount less than or equal to 40, or, more specifically, less than or equal to 35, or, even more specifically, less than or equal to 32 weight percent based on the total weight of the flame retardant thermoplastic composition.

Additionally, the fire retardant thermoplastic composition may optionally also contain various additives, for example antioxidants, such as organophosphites, including tris(nonyl-phenyl)phosphite, tris(2,4-di-t-butylphenyl)phosphite, bis(2,4-di-t-butylphenyl)pentaerythritol diphosphite or distearyl pentaerythritol diphosphite, alkylated monophenols, polyphenols and alkylated reaction products of polyphenols with dienes, such as, for example, tetrakis[methylene(3,5-di-tert-butyl-4-hydroxyhydrocinnamate)] methane, 2,4-di-tert-butylphenyl phosphite, butylated reaction products of para-cresol and dicyclopentadiene, alkylated hydroquinones, hydroxylated thiodiphenyl ethers, alkylidene-bisphenols, benzyl compounds, esters of beta-(3,5-di-tert-butyl-4-hydroxyphenyl)-propionic acid with monohydric or polyhydric alcohols, esters of beta-(5-tert-butyl-4-hydroxy-3-methylphenyl)-propionic acid with monohydric or polyhydric alcohols, esters of thioalkyl or thioaryl compounds, such as, for example, distearylthiopropionate, dilaurylthiopropionate, ditridecylthiodipropionate, amides of beta-(3,5-di-tert-butyl-4-hydroxyphenyl)-propionic acid; fillers and reinforcing agents, such as silicates, TiO₂, fibers, glass fibers (including continuous and chopped fibers), carbon black, graphite, calcium carbonate, talc, and mica; mold release agents; UV absorbers; stabilizers such as light stabilizers and others; lubricants; plasticizers; pigments; dyes; colorants; anti-static agents; and blowing agents.

The flame retardant thermoplastic composition is blended under conditions appropriate to the formation of an intimate blend. The components are combined and mixed, using equipment such as an extruder or kneader, typically at a temperature sufficient to allow melt mixing without substantial decomposition of any of the components. In one embodiment components may be blended in a twin screw extruder at a temperature of 200° C. to 300° C. If using, for example, a 53 millimeter twin screw extruder the screw speed may be 200 to 400 rotations per minute (rpm).

In one embodiment the phosphoric acid salt, metal hydroxide and organic phosphate are blended with a thermoplastic either at a temperature above the melt temperature of the thermoplastic (melt mixing) or at a temperature below the melt temperature of the thermoplastic to form a masterbatch. The masterbatch can then be melt mixed with the components of the flame retardant composition. The masterbatch may be added initially or after some mixing of the components of flame retardant composition.

In another embodiment the phosphoric acid salt, metal hydroxide and organic phosphate are premixed, without thermoplastic, to form a flame retardant additive mixture. The flame retardant additive mixture may be added at any point along the formation of the flame retardant thermoplastic composition such as at the beginning of the melt mixing of the thermoplastic or during the melt mixing of the thermoplastic. Alternatively the flame retardant additive mixture may be melt mixed with a pelletized thermoplastic blend.

In another embodiment the phosphoric acid salt, metal hydroxide, and organic phosphate are added directly to the components of the thermoplastic composition. They may be added together or separately and at any point during melt mixing provided the composition is sufficiently melt mixed to disperse the flame retardant additive composition components.

In one embodiment a fire retardant additive masterbatch comprises 30 to 70 of the flame retardant additive composition and 30 to 70 of a diluent material. The diluent material may be a solid or liquid and may serve as a binder for the fire retardant additive composition. While the identity of the diluent is not crucial the choice of diluent material is typically made with consideration of the resin or resins the masterbatch is to be combined with. For example if the masterbatch is to be combined with poly(arylene ether) the choices for the diluent material could include poly(arylene ether) or a material compatible with poly(arylene ether) such as polystyrene, polyolefin as described above, or impact modifier as described above.

The compositions are further illustrated by the following non-limiting examples.

### EXAMPLES

The following examples employed the materials listed in Table 1. All weight percents employed in the examples are based on the weight of the entire composition except where stated.

TABLE 1

| Component | Description/Supplier |
|---|---|
| PPE | Poly(phenylene ether) having an intrinsic viscosity |
| | of 0.46 g/dl when measure in chloroform at 25° C. |
| SEBS I | Polystyrene-poly(ethylene-butylene)-polystyrene having |
| | a polystyrene content of 13 weight percent that is |
| | commercially available from Kraton Polymers Ltd under |
| | the tradename Kraton G1657. |
| SEBS II | Polystyrene-poly(ethylene-butylene)-polystyrene having |
| | a polystyrene content of 30 weight percent that is |
| | commercially available from Kraton Polymers Ltd |
| | under the tradename Kraton G1650. |
| SEBS III | Polystyrene-ethylene-butylene/styrene-polystyrene |
| | commercially available from Kraton Polymers Ltd |
| | under the tradename Kraton A, grade RP 6936. |
| LLDPE | Linear low density polyethylene commercially |
| | available from Nippon Unicar Co. Ltd under |
| | the tradename NUCG5381. |
| Polybutene | Polybutene commercially available from BP Chemical |
| | under the tradename Indopol, grade H100. |
| RDP | Resorcinol diphosphate commercially available |
| | from Great Lakes Chemical Co. Ltd. under |
| | the trade name of Reofos RDP. |
| MPP | Melamine polyphosphate commercially available |
| | from Ciba Specialty Chemical Co. Ltd under |
| | the tradename Melapur 200. |
| Mg(OH)₂ | Magnesium hydroxide commercially available from |
| | Kyowa Chemical Industry Co. Ltd. under the trade |
| | name of Kisuma 5A. |
| BTPP | Butylated triphenyl phosphate commercially available |
| | from Akzo Nobel Chemical Inc. under the tradename |
| | Phosflex 71B. |
| TPP | Triphenyl phosphate commercially available from |
| | Akzo Nobel Chemical Inc. under the tradename |
| | Phosflex TPP. |
| BPADP | Bisphenol A disphosphate commercially available |
| | from Akzo Nobel Chemicals Inc under the tradename |
| | of Fyroflex BDP. |
| LDPE | Low density polyethylene commercially available from |
| | Nippon Unicar Co. Ltd under the tradename NUC8042. |
| EEA | Ethylene-vinyl acetate copolymer commercially |
| | available from Dupont Mitsui Polymers Co |
| | Ltd under the tradename Elvaloy A710. |
| EVA | Ethylene-ethyl acrylate copolymer commercially |
| | available from Nippon Unicar Co. Ltd |
| | under the tradename NUC8451. |

### Examples 1-9

A thermoplastic composition containing 38.5 weight percent PPE, 26.9 weight percent SEBS I, 25.6 weight percent LLDPE and 9.0 weight percent polybutene, based on the total weight of thermoplastics was melt mixed with RDP, MPP, and Mg(OH)₂ in the amounts shown in Table 2. The amounts of RDP, MPP and Mg(OH)₂ amounts are shown in parts per hundred parts of thermoplastic composition (PPE+SEBS I+LLDPE+polybutene). The composition was molded into 3.2 millimeter bars for flammability testing. Flammability tests were performed following the procedure of Underwriter's Laboratory Bulletin 94 entitled “Tests for Flammability of Plastic Materials, UL94”. Each bar that extinguished was ignited twice. According to this procedure, the materials were classified as either HB, V0, V1 or V2 on the basis of the test results obtained for five samples. The criteria for each of these flammability classifications according to UL94, are, briefly, as follows.

HB: In a 5 inch sample, placed so that the long axis of the sample is parallel to the flame, the rate of burn of the sample is less than 3 inches per minute, and the flames should be extinguished before 4 inches of sample are burned.

V0: In a sample placed so that its long axis is parallel to the flame, the average period of flaming and/or smoldering after removing the igniting flame should not exceed five seconds and none of the vertically placed samples should produce drips of burning particles which ignite absorbent cotton.

V1: In a sample placed so that its long axis is parallel to the flame, the average period of flaming and/or smoldering after removing the igniting flame should not exceed twenty-five seconds and none of the vertically placed samples should produce drips of burning particles which ignite absorbent cotton.

V2: In a sample placed so that its long axis is parallel to the flame, the average period of flaming and/or smoldering after removing the igniting flame should not exceed twenty-five seconds and the vertically placed samples produce drips of burning particles which ignite cotton.

Results are shown in Table 2. Burn time is the sum of the amounts of time the bar burned each time it was lit. “Burn” indicates that the bar did not self-extinguish. “NA” in the UL94 rating column means that the sample did not fall within the parameters of any of the UL94 ratings.

TABLE 2

| Example | RDP | MPP | Mg(OH)₂ | Burn time | UL94 rating |
|---|---|---|---|---|---|
| 1* | 19.3 | 19.3 | 0 | Burn | NA |
| 2 | 19.3 | 19.3 | 8.3 | 5.5 | V0 |
| 3 | 19.3 | 19.3 | 13.9 | 1.5 | V0 |
| 4* | 27.7 | 16.6 | 0 | Burn | NA |
| 5 | 27.7 | 11.1 | 8.3 | 3.8 | V0 |
| 6* | 24.9 | 0 | 12.5 | Burn | NA |
| 7* | 0 | 27.7 | 8.3 | Burn | NA |
| 8* | 23.8 | 19.1 | 0 | Burn | NA |
| 9* | 22.2 | 19.4 | 0 | Burn | NA |

*Comparative Example

Examples 1-9 demonstrate that all three components of the flame retardant additive composition are required for flame retardance. Examples 1, 4, 8, and 9 all lack magnesium hydroxide and none of these samples self-extinguished. Example 6 lacked melamine polyphosphate and did not self extinguish. Example 7 lacked resorcinol diphosphate and it too did not self extinguish. The fact that all three components of the fire retardant additive composition are required indicates an unexpected synergistic relationship between the three components.

### Examples 10-15

A thermoplastic composition containing 42.6 weight percent PPE, 32.0 weight percent SEBS I, 21.4 weight percent LLDPE and 4.0 weight percent polybutene, based on the total weight of thermoplastics, was melt mixed with BTPP, RDP, MPP, and Mg(OH)₂ in the amounts shown in Table 3. BTPP, RDP, MPP, and MgOH)₂ amounts are in parts per hundred parts of thermoplastic composition (PPE+SEBS I+LLDPE+polybutene). The composition was molded into 3.2 millimeter bars for flammability testing and tested as described in Examples 1-9.

TABLE 3

| | | | | | Burn | UL94 |
|---|---|---|---|---|---|---|
| Example | BTPP | RDP | MPP | Mg(OH)₂ | time | rating |
| 10 | 3.9 | 19.3 | 11.4 | 7.7 | 5.2 | V0 |
| 11 | 0 | 19.3 | 11.4 | 7.7 | 17.4 | V1 |
| 12 | 0 | 24.4 | 12.8 | 7.7 | 2.9 | V0 |
| 13 | 0 | 25.7 | 7.7 | 7.7 | 1.9 | V0 |
| 14 | 6.4 | 19.3 | 11.4 | 11.4 | 24.2 | V1 |
| 15 | 10.3 | 15.4 | 7.7 | 10.3 | 8.8 | V0 |

Examples 10-15 demonstrate that combinations of organic phosphate are useful in the flame retardant additive composition and that excellent flame retardance (V1 and V0) can be achieved with the fire retardant additive composition.

### Examples 16-19

26 weight percent PPE, 25 weight percent SEBS I, 15.0 weight percent polyethylene copolymer (as shown in Table 4) and 2 weight percent polybutene, based on the total weight of the composition, were melt mixed with BTPP, RDP, MPP, and Mg(OH)₂ in the amounts shown in Table 4. BTPP, RDP, MPP, and Mg(OH)₂ amounts are shown in weight percent, based on the total weight of the composition. The compositions were molded into 2.0 millimeter bars for flammability testing and tested as described in Examples 1-9. In Example 19 one out of 10 burns caused dripping at 20 seconds, which resulted in a V2 rating.

TABLE 4

| | PE | | | | | Burn | UL94 |
|---|---|---|---|---|---|---|---|
| Example | copolymer | BTPP | RDP | MPP | Mg(OH)₂ | time | rating |
| 16 | LDPE | 8.0 | 12.0 | 5.0 | 7.0 | 3.4 | V0 |
| 17 | LLDPE | 8.0 | 12.0 | 5.0 | 7.0 | 9.5 | V1 |
| 18 | EEA | 8.0 | 12.0 | 5.0 | 7.0 | 3.1 | V0 |
| 19 | EVA | 8.0 | 12.0 | 5.0 | 7.0 | 12.3 | V2 |

Examples 16-19 demonstrate that compositions containing a significant amount of polyolefin and comprising a variety of polyethylene copolymers can attain a V2 rating or better using the flame retardant additive composition.

### Example 20

26 weight percent PPE, 25 weight percent SEBS I, 15.0 weight percent EEA and 2 weight percent polybutene were melt mixed with 8.0 weight percent BTPP, 12.0 weight percent RDP, 5.0 weight percent melamine cyanurate, and 7 weight percent Mg(OH)₂, where all weight percents are based on the total weight of the composition. The composition was molded into 2.0 millimeter bars for flammability testing and tested as described in Examples 1-9. The composition did not self extinguish indicating that phosphoric acid salt cannot be replaced by a nitrogen containing compound free of phosphorous, further confirming the surprising synergistic relationship between the three components of the fire retardant additive composition.

### Examples 21-33

Compositions according to the formulations shown in Table 5 were made and tested for tensile strength and elongation according to ASTM D 638, flexural modulus according to ASTM D790 and shore A hardness according to ASTM D2240. Formulation amounts are in weight percent based on the total weight of the compositions. Tensile strength values are in megapascals (MPa) and tensile elongation values are in percent. Flexural modulus values are in MPa.

The compositions were molded into 2.0 millimeter bars for flammability testing and tested as described in Examples 1-9. Results are shown in Table 6.

TABLE 5

| Example | PPE | SEBS I | SEBS II | LLDPE | EEA | LDPE | PB | MPP | Mg(OH)₂ | BTPP | RDP |
|---|---|---|---|---|---|---|---|---|---|---|---|
| 21 | 25.2 | 29.1 | — | — | 13.6 | — | 2.9 | 4.9 | 6.8 | 7.8 | 9.7 |
| 22 | 25.9 | 23.5 | 3.0 | — | 14.3 | — | 2.7 | 5.4 | 7.0 | 7.1 | 10.7 |
| 23 | 25.0 | 25.5 | 3.8 | — | 10.6 | — | 2.9 | 5.3 | 7.7 | 7.7 | 11.5 |
| 24 | 25.2 | 26.2 | 1.9 | — | 14.6 | — | 2.9 | 4.9 | 5.8 | 8.7 | 9.7 |
| 25 | 25.2 | 26.2 | 1.9 | 2.9 | 14.6 | — | — | 4.9 | 5.8 | 8.7 | 9.7 |
| 26 | 25.2 | 28.2 | — | — | 17.5 | — | — | 5.3 | 5.3 | 8.7 | 9.7 |
| 27 | 30.8 | 21.5 | — | 15.0 | — | — | 2.8 | 5.6 | 5.6 | — | 18.7 |
| 28 | 26.1 | 23.4 | — | 17.1 | — | — | 2.7 | 8.1 | 4.5 | 4.5 | 13.5 |
| 29 | 32.0 | 35.0 | — | — | 5.0 | — | — | 5.0 | 6.0 | — | 17.0 |
| 30 | 35.0 | 20.0 | — | — | 17.0 | — | — | 5.0 | 6.0 | — | 17.0 |
| 31 | 35.0 | 22.0 | 10.0 | — | 5.0 | — | — | 5.0 | 6.0 | — | 17.0 |
| 32 | 26.0 | 27.0 | — | — | — | 14.0 | 2.0 | 5.0 | 6.0 | 9.0 | 11.0 |
| 33 | 25.1 | 28.2 | — | — | 14.6 | — | 2.9 | 4.9 | 6.8 | 7.8 | 9.7 |

TABLE 6

| | Tensile | Tensile | Flexural | Durometer | |
|---|---|---|---|---|---|
| | Strength | Elongation | Modulus | Hardness | UL 94V |
| Example | (MPa) | (%) | (MPa) | (Shore A) | Rating |
| 21 | 8.7 | 315 | 81 | 82 | V1 |
| 22 | 12.4 | 326 | 257 | 88 | V1 |
| 23 | 11.3 | 349 | 246 | 88 | V1 |
| 24 | 11.0 | 340 | 150 | 85 | V0 |
| 25 | 11.2 | 318 | 214 | 89 | V0 |
| 26 | 10.7 | 299 | 196 | 87 | V1 |
| 27 | 13.9 | 207 | 328 | 92 | V1 |
| 28 | 9.5 | 282 | 161 | 88 | V1 |
| 29 | 14.3 | 318 | 310 | 91 | V1 |
| 30 | 17.6 | 184 | 530 | 95 | V0 |
| 31 | 18.1 | 188 | 666 | 97 | V0 |
| 32 | 13.4 | 296 | 322 | 91 | V0 |
| 33 | 9.0 | 309 | 102 | 83 | V1 |

The data in Table 6 demonstrates that the fire retardant thermoplastic composition can obtain a surprising combination of physical properties, namely softness, flexibility and tensile strength as well as flame retardance, without the use of halogenated flame retardants. None of Examples 21-33 exhibited plate out or migration by visual inspection.

Additionally Examples 22, 23 and 33 were tested for viscosity using a capillary viscometer having a length to diameter ratio of 10. Viscosity values are in Pascal seconds (Pa s). Data for Example 22 is shown in Table 7. Data for Example 23 is shown in Table 8. Data for Example 33 is shown in Table 9.

TABLE 7

| | Shear rate (s⁻¹) | | | | |
|---|---|---|---|---|---|
| Temperature | 10 | 100 | 1,000 | 4,000 | 10,000 |
| 210° C. | 2584 | 1002 | 293 | 134 | 81 |
| 230° C. | 2031 | 650 | 199 | 90 | 53 |
| 250° C. | 826 | 474 | 143 | 70 | 40 |

TABLE 8

| | Shear rate (s⁻¹) | | | | |
|---|---|---|---|---|---|
| Temperature | 10 | 100 | 1,000 | 4,000 | 10,000 |
| 210° C. | 2022 | 959 | 283 | 128 | 73 |
| 230° C. | 2189 | 632 | 196 | 88 | 50 |
| 250° C. | 1608 | 453 | 139 | 68 | 40 |

TABLE 9

| | Shear rate (s⁻¹) | | | | |
|---|---|---|---|---|---|
| Temperature | 10 | 100 | 1,000 | 4,000 | 10,000 |
| 210° C. | 1988 | 750 | 237 | 113 | 71 |
| 230° C. | 1384 | 534 | 175 | 83 | 50 |
| 250° C. | 1001 | 373 | 126 | 63 | 38 |

The data in Tables 7-9 demonstrate that the compositions have excellent processability, particularly for extrusion processes.

### Examples 34-37

Compositions according to the formulations shown in Table 10 were made and tested for tensile strength and elongation according to ASTM D 638, flexural modulus according to ASTM D790 and shore A hardness according to ASTM D2240. Formulation amounts are in weight percent based on the total weight of the composition. Tensile strength values are in megapascals (MPa) and tensile elongation values are in percent. Flexural modulus values are in MPa.

The compositions were molded into 3.2 millimeter bars for flammability testing and tested as described in Examples 1-9. Results are shown in Table 11.

TABLE 10

| | | SEBS | | | | | | |
|---|---|---|---|---|---|---|---|---|
| Example | PPE | III | EEA | LLDPE | PB | MPP | Mg(OH)₂ | RDP |
| 34 | 19.0 | 30.0 | — | 19.0 | 6.0 | 5.0 | 6.0 | 15.0 |
| 35 | 25.8 | 28.3 | 12.9 | — | 5.3 | 4.8 | 5.7 | 17.2 |
| 36 | 23.0 | 31.1 | 12.9 | — | 5.3 | 4.8 | 5.7 | 17.2 |
| 37 | 25.8 | 31.1 | 10.1 | — | 5.3 | 4.8 | 5.7 | 17.2 |

TABLE 11

| | Tensile | Tensile | Flexural | Durometer | |
|---|---|---|---|---|---|
| | Strength | Elongation | Modulus | Hardness | UL 94V |
| Example | (MPa) | (%) | (MPa) | (Shore A) | Rating |
| 34 | 13.8 | 530 | 210− | 89 | V1 |
| 35 | 15.8 | 413 | 306 | 92 | V0 |
| 36 | 13.5 | 507 | 235 | 89 | V0 |
| 37 | 15.9 | 407 | 290 | 91 | V0 |

Examples 34 through 37 demonstrate flame retardant thermoplastic materials having an excellent combination of properties, notably high values for tensile elongation indicating materials having a resistance to breakage under stress such as stress exerted by pulling. The flame retardant thermoplastic materials also demonstrate a combination of softness (as demonstrated by the Shore A values), good flame resistance, tensile strength, and flexural modulus.

While the invention has been described with reference to various embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All cited patents are incorporated by reference herein.

1. A flame retardant additive composition comprising:
a phosphoric acid salt selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide and combinations of two or more of the foregoing;
a metal hydroxide; and
an organic phosphate.

2. The composition of claim 1 wherein the phosphoric acid salt is present in an amount of 10 to 40 weight percent based on the total weight of the composition.

3. The composition of claim 1 wherein the metal hydroxide is present in an amount of 10 to 45 weight percent based on the total weight of the composition.

4. The composition of claim 1 wherein the organic phosphate is present in an amount of 15 to 80 weight percent based on the total weight of the composition.

5. The composition of claim 1 wherein the organic phosphate is selected from the group consisting of butylated triphenyl phosphate, resorcinol diphosphate, bis-phenol A diphosphate, triphenyl phosphate, isopropylated triphenyl phosphate, and combinations of two or more of the foregoing.

6. The composition of claim 1 wherein the phosphoric acid salt is melamine polyphosphate.

7. The composition of claim 1 wherein the metal hydroxide comprises magnesium hydroxide, aluminum hydroxide, cobalt hydroxide and combinations of two or more of the foregoing.

8. The composition of claim 1 wherein the metal hydroxide comprises magnesium hydroxide.

9. The composition of claim 1 further comprising a diluent material.

10. A flame retardant thermoplastic composition comprising:
a thermoplastic resin;
a phosphoric acid salt selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide and combinations of two or more of the foregoing;
a metal hydroxide; and
an organic phosphate.

11. The flame retardant thermoplastic composition of claim 10 wherein the thermoplastic resin is selected from the group consisting of poly(arylene ether), poly(arylene ether) blends, styrenic polymers and copolymers and their blends, polyolefin, polyolefin blends, polyethers and their blends, polyamides and their blends.

12. The flame retardant thermoplastic composition of claim 11 wherein the poly(arylene ether) blend is selected from the group consisting of compatibilized poly(arylene ether)/polyamide, poly(arylene ether)/polyolefin, poly(arylene ether)/olefinic thermoplastics vulcanizates, poly(arylene ether)/ethylene-propylene rubber, poly(arylene/ether)/EPDM, poly(arylene ether)/styrenic polymer, poly(arylene ether)/styrenic copolymer, impact modified poly(arylene ether) and poly(arylene ether)/thermoplastic polyurethane.

13. The composition of claim 10 wherein the phosphoric acid salt is present in an amount of 10 to 40 weight percent, the metal hydroxide is present in an amount of 10 to 45 weight percent and the organic phosphate is present in an amount of 15 to 80 weight percent based on the total weight of phosphoric acid salt, metal hydroxide and organic phosphate and the combination of phosphoric acid salt, metal hydroxide and organic phosphate is present in an amount of 15 to 45 weight percent based on the total weight of the thermoplastic composition.

14. The composition of claim 10 wherein the organic phosphate is selected from the group consisting of butylated triphenyl phosphate, resorcinol diphosphate, bis-phenol A diphosphate, triphenyl phosphate, isopropylated triphenyl phosphate, and mixtures containing two or more of the foregoing.

15. The composition of claim 10 wherein the phosphoric acid salt is melamine polyphosphate.

16. The composition of claim 10 wherein the metal hydroxide comprises magnesium hydroxide, aluminum hydroxide, cobalt hydroxide and combinations of two or more of the foregoing.

17. The composition of claim 10 wherein the metal hydroxide comprises magnesium hydroxide.

18. A flame retardant thermoplastic composition comprising:
poly(arylene ether);
an impact modifier;
a polyolefin;
a phosphoric acid salt selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide, melem polyphosphate, melam polyphosphate and combinations of two or more of the foregoing;
a metal hydroxide; and
an organic phosphate.

19. The composition of claim 18 wherein the impact modifier comprises a combination of a first block copolymer having a styrene content of 10 weight percent to 20 weight percent based on the total weight of the first block copolymer and a second block copolymer having a styrene content of 25 weight percent to 50 weight percent based on the total weight of the second block copolymer.

20. The composition of claim 18 wherein the impact modifier comprises a block copolymer comprising an alkenyl aromatic block and a rubber block wherein the alkenyl aromatic block and/or rubber block comprise a copolymer resulting from the copolymerization of a conjugated diene and an alkenyl aromatic compound and further wherein the units resulting from the polymerization of the conjugated diene are partially or completely hydrogenated.

21. The composition of claim 18 wherein the composition has a Shore A hardness, as determined by ASTM D 2240, of 75 to 95 and a flexural modulus, as determined by ASTM D790 using bars with a thickness of 6.4 millimeters, of less than or equal to 1172 megapascals.

22. The composition of claim 18 wherein the impact modifier comprises a polystyrene-poly(ethylene-butylene)-polystyrene block copolymer.

23. The composition of claim 18 wherein the composition has a Shore D hardness, as determined by ASTM D 2240, of 20 to 60.

24. The composition of claim 18 wherein the composition has a tensile strength greater than or equal to 7.0 megapascals and a tensile elongation greater than or equal to 100% and further wherein tensile strength and tensile elongation are determined by ASTM D638.

25. The composition of claim 24, wherein the tensile elongation is greater than or equal to 300%.

26. The composition of claim 18 wherein the composition has a flame retardancy rating, according to UL94, of V2 or better.

27. The composition of claim 18 wherein the block copolymer comprises a polystyrene-(ethylene-butylene/styrene copolymer)-polystyrene block copolymer.

28. The composition of claim 18 wherein the poly(arylene ether) is present in an amount of 10 to 65 weight percent, the impact modifier is present in an amount of 5 to 50 weight percent, the polyolefin is present in an amount of 5 to 50 weight percent and the combination of phosphoric acid salt, metal hydroxide and organic phosphate is present in an amount of 15 to 45 weight percent, based on the total weight of the composition.

29. The composition of claim 18 wherein the polyolefin comprises a homopolymer, a copolymer of ethylene and an alpha olefin having three to twelve carbons, a copolymer of ethylene and a functionalized alpha olefin having three to twelve carbons or a combination of two or more of the foregoing.

30. The composition of claim 18 wherein the organic phosphate is selected from the group consisting of butylated triphenyl phosphate, resorcinol diphosphate, bis-phenol A diphosphate, triphenyl phosphate, isopropylated triphenyl phosphate, and mixtures containing two or more of the foregoing.

31. The composition of claim 18 wherein the phosphoric acid salt is melamine polyphosphate.

32. The composition of claim 18 wherein the metal hydroxide comprises magnesium hydroxide, aluminum hydroxide, cobalt hydroxide and combinations of two or more of the foregoing.

33. The composition of claim 18 wherein the metal hydroxide comprises magnesium hydroxide.

34. A coated wire comprising an electrically conductive wire at least partially covered by the thermoplastic composition of claim 18.

35. A flame retardant thermoplastic composition consisting essentially of poly(arylene ether), an impact modifier, a polyolefin, and a fire retardant additive composition consisting of a phosphoric acid salt selected from the group consisting of melamine phosphate, melamine pyrophosphate, melamine orthophosphate, ammonium phosphate, ammonium phosphate amide, phosphoric acid amide, melamine polyphosphate, ammonium polyphosphate, ammonium polyphosphate amide, polyphosphoric acid amide, melem polyphosphate, melam polyphosphate and combinations of two or more of the foregoing, a metal hydroxide and an organic phosphate.
